(19) United States
(12) Patent Application Publication
(10) Pub. No.: US 2012/0026737 A1
(43) Pub. Date: Feb. 2, 2012

(54) OUTDOOR LIGHTING UNIT

(75) Inventors: Mustafa Dinc, Heilbronn (DE); Norbert Pieper, Selb (DE); Gerd Schnorrenberg, Dahlem (DE)

(73) Assignee: VISHAY ELECTRONIC GMBH, Selb (DE)

(21) Appl. No.: 13/262,760

(22) PCT Filed: Mar. 30, 2010
(86) PCT No.: PCT/EP2010/002031

§ 371 Date: Oct. 3, 2011

(30) Foreign Application Priority Data
Apr. 3, 2009 (DE) 102009016256.9

(51) Int. Cl. F21V 21/00; F21V 29/00; F21V 7/00

(52) U.S. Cl. 362/247; 362/235; 362/249.02

(57) ABSTRACT

The invention relates to an outdoor lighting unit for lighting streets, pavements, industrial grounds, and the like, comprising one LED light source which includes several light emitting diodes in a two-dimensional array, and a housing. The housing has a single-piece solid housing element, which has at least one planar assembly section on an underside, on which a backside of the LED light source is arranged in heat-conducting connection in a planar manner. The housing element further has on said underside a circumferential wall section, which projects downwardly from the plane of the assembly section. Further, the housing element comprises an exposed cooling section on an upper side, which is convexly curved and has several cooling channels, which extend along the convex curvature. The housing element also comprises a holding portion, by means of which the lighting unit can be secured to a holding device in a self-supporting manner.

The invention relates to an outdoor lighting unit for lighting streets, sidewalks, outdoor industrial installation and the like (e.g. also railroad installations, aircraft runways, parking areas, houses, camping sites, sports fields, etc.).

It is known for such outdoor lighting units to provide an LED light source which has a plurality of light emitting diodes and which is characterized by high reliability and a long service life. It is, however, important not to exceed a predefined operating temperature on the use of an LED light source. It is furthermore important to protect the LED light source against contamination and weather influences. These measures should be achieved with a small manufacturing effort. Furthermore, the outdoor lighting unit should be able to be easily adapted to different applications or customer wishes.

It is an object of the invention to provide an outdoor lighting unit which ensures an effective cooling of the LED light source and protection against environmental influences with a simple manufacture.

This object is satisfied by an outdoor lighting unit having the features of claim 1. This lighting unit has an LED light source with a plurality of light emitting diodes in a two-dimensional arrangement, i.e. an areal arrangement. The lighting unit furthermore has a housing which includes a single-part, solid housing element. This housing element has at its lower side (with respect to the position of use of the lighting unit) at least one planar installation section at which a rear side of the LED light source is fastened areally and in a thermally conductive connection. The housing element furthermore has at the lower side a peripheral marginal section which projects downwardly with respect to the plane of said installation section (again with respect to the position of use of the lighting unit). At its upper side, the housing element has an exposed cooling section which is convexly curved and has a plurality of cooling passages which extend along the convex curvature. The housing element additionally includes a holding section by means of which the lighting unit can be fastened in a self-supporting manner to a mast, for example.

Since the housing element is made in one piece with said different sections and in a solid manner, the housing element not only serves for the reception of the LED light source. The housing element rather also forms an effective heat sink for the LED light source with a high heat capacity and good thermal conductivity from the installation section for the LED light source to all said further sections of the housing element. Due to the areal arrangement of the LED light source at the installation section of the housing element, an efficient transfer of the waste heat of the LED light source to the housing element is ensured, with a direct areal contact, an indirect areal contact e.g. via a thermally conductive paste) or a slight air gap being able to be provided. Due to the one-part design, a simple manufacture of the housing element and a simple installation of the lighting unit are also possible.

An installation volume in which the LED light source can be arranged, in particular together with a reflector device, is formed by the peripheral wall section of the housing element at its lower side. The downwardly projecting arrangement of the wall section (again with respect to the position of use of the lighting unit) corresponds to a bell-like enclosing of the LED light source, whereby particularly good protection against environmental influences is ensured.

Whereas the total housing element acts as a heat sink for the waste heat of the LED light source due to its solid design, the upper side of the housing element (that is the substantially upwardly facing outer side in the position of use of the lighting unit) serves as a cooling section in order effectively to output the heat taken up by the LED light source to the environment. This cooling section is exposed, i.e. it is directly exposed to the environment of the lighting unit. An air flow can be used particularly effectively for cooling purposes due to the convex curvature of the cooling section and due to the formation of a plurality of cooling passages. Environmental air which is heated by the housing element and flows upwardly is namely guided along the cooling passages, whereby an increase of the throughflow speed (passage effect) and an increase of the surface covered by the air flow result. Furthermore, a cooling of the housing element and self-cleaning effects are possible by precipitation which impacts on the housing element from above and flows off downwardly along the cooling passages (rain, melted snow or melted ice).

Due to the integral formation of a holding section at said housing element (for example a joint section or a fastening flange) not only a particularly simple structure of the lighting unit with few components results, but also a good thermal transfer to the holding device which can thus serve as an additional heat sink, in particular for adjacently arranged electronic or electrical components of the lighting unit with a particularly high thermal output (e.g. power pack, control unit).

Advantageous embodiments are described in the following and are named in the dependent claims.

In accordance with an advantageous embodiment, the housing element extends, starting from said holding section, along a lengthways direction, with the cooling passages of the cooling section extending substantially perpendicular to this lengthways direction. The lighting unit, which is anyway characterized by a high stability due to the one-part design of the explained housing element, can hereby withstand particularly high wind loads. If the wind namely does not engage at the relatively narrow front side or rear side, but rather at one of the lengthways sides of the housing element, the reduced air resistance makes itself advantageously noticeable due to the cooling passages extending in the transverse direction. This is in particular of importance when the lighting unit is used for lighting streets since the lighting unit is typically arranged freestanding in this case and is only supported by a mast as a holding device so that the lighting unit is exposed to the air flows without protection.

A particularly inexpensive manufacture of the housing element results when it is formed as a casting, for example from a light metal.

The housing element is preferably made from an aluminum alloy resistant to sea water, and indeed without any special surface treatment at the upper side, that is at said cooling section. An AlMg alloy or AlMgMn alloy can be used for this purpose, for example (in particular AlMg2Mn0.8 or AlMg4.5Mn). If no natural oxide layer forms at the housing element and also no anodic oxidation (anodization) is carried out, a better self-cleaning effect namely results at the upper side of the housing element, whereby a better thermal output to the environment is ensured in the long term. If, furthermore, no additional layers are applied to the upper side (e.g.

lacquer), a thermal insulation by outermost layers is avoided, which likewise contributes to a good thermal transfer to the environment. If this additional effect is not required for a desired application, a housing element can, however, also be used made from an aluminum alloy resistant to sea water and having an additional surface protection (e.g. lacquer, coating).

To achieve a particularly effective overflow of the cooling section of the housing element at the upper side, said cooling passages preferably have a width at half their depth which is at least 2.5 times as large (e.g. approx. 3 times as large) as the width of ribs which are formed between the cooling passages at the cooling section.

It is preferred in this respect if said cooling passages have a width of at least 10 mm, in particular a width of at least 15 mm, at half their depth. It is furthermore preferred if the cooling passages have a depth of at least 15 mm.

A desired self-cleaning effect at the upper side of the housing element is amplified by the aforesaid proportions and widths since, for example, rainwater can penetrate easily into the cooling passages without disturbing surface tension effects, can wet them, flow out of the cooling passages and in so doing can also take along contaminants.

The cooling passages preferably converge toward the base, with the base of the cooling passages being concavely curved in cross-section, for example with a radius of curvature of approximately 5 mm. Air turbulence can hereby arise at the base of the cooling passages which has an advantageous effect on the thermal transfer from the cooling section of the housing element to the environment.

In addition to said housing element, the housing of the lighting unit can have a cover device which can be fastened to the lower side of the wall section of the housing element and which is transparent at least in the region of the LED light source. Such a cover device serves for the protection from environmental influences.

Said cover device can be thermally conductively connected to the peripheral wall section of the housing element so that the cover device also forms a heat sink for the waste heat of the LED light source.

The spacing between the light emitting diodes of the LED light source and the cover device preferably amounts to at least 10 mm, in particular to at least 15 mm. It is hereby ensured that sufficient air circulation can form within the housing in order also to lead off waste heat of the light emitting diode convectively and to transfer it to different housing regions and thus to provide a uniform heat distribution.

Said cover device can be pivotably connected to the housing element to allow a simple access to the inner housing space (for example, for servicing purposes).

As regards said LED light source, it preferably has an electric insulation layer at the rear side to allow an areal, mechanical connection to the installation section of the typically metallic housing element.

The LED light source can be screwed, riveted or adhesively bonded to the installation section of the housing element, in particular using a thermally conductive adhesive.

The housing element can have at least two separate installation sections for a respective module of the LED light source at its lower side, with the installation sections extending along different planes (i.e. at different heights) or being arranged inclined with respect to one another (i.e. at an angle different from 180°.

In accordance with a particularly advantageous embodiment, the LED light source selectively has one or more modules which have an anisotropic radiation angle characteristic, i.e. a different radiation flow is transmitted in different spatial angle ranges (X/Y characteristic). In this embodiment, the installation section of the housing element is formed to selectively receive a single module (having a predefined radiation angle characteristic), or a plurality of modules (having a respective predefined radiation angle characteristic) in a lengthways arrangement, or a plurality of modules of the LED light source in a transverse arrangement. In other words, the plurality of modules can selectively be arranged next to one another in a lengthways direction or next to one another in a transverse direction. The lighting unit can hereby be adapted in a simple manner to different applications or customer wishes (variable configuration of the installation section of the housing element in accordance with a “modular principle”).

Said modules of the LED light source can have a substantially square outline, for example, to allow a simple arrangement or a multiple arrangement in different directions. It is, however, generally also possible that said modules, for example, have a rectangular, a round or a hexagonal shape.

It is furthermore preferred if not only one variation is possible with respect to different arrangements in different directions. Alternatively or additionally, a variation of the alignment can also be provided, i.e. a module of the light source having a specific X/Y characteristic can selectively also be fastened to the installation section of the housing element in an alignment rotated by 90°. The lighting unit can also hereby be easily adapted to different applications or customer wishes—with an otherwise unchanged structure. In this respect, any desired intermediate positions are also possible (i.e. different angles to 90°, in particular when said modules of the LED light source are round or hexagonal.

It is particularly preferred if the installation section of the housing element has a “+” shape, i.e. if the installation section is substantially cruciform. In this case, a plurality of modules of the LED light source can selectively be fastened to the installation section next to one another in a lengthways arrangement or in a transverse arrangement.

The surface of the installation section of the housing element in accordance with a further embodiment has a lower roughness than the surface of the cooling section. Whereas an increased roughness at the surface of the cooling section can contribute to an improved thermal transfer from the housing element to the environment, a relatively small roughness of the surface of the installation section effects a better thermal transition from the LED light source to the installation section of the housing element areally connected hereto.

The LED light source preferably includes a carrier device to which the plurality of light emitting diodes are electrically conductively and thermally conductively fastened, with a rear side of this carrier device being arranged areally and in a thermally conductive connection at the installation section of the housing element. Said carrier device is preferably made areally thermally conductive at least along a layer to distribute the heat generated by the light emitting diodes areally along the carrier device and also to transfer it areally from the carrier device to the installation section of the housing element. Unwanted, so-called “hot-spots” which could have a negative effect on the operating behavior of the light emitting diodes are hereby effectively avoided.

Said peripheral wall section at the lower side of the housing element can surround an installation volume in which the LED light source is arranged together with an associated reflector device.

In accordance with a particularly advantageous embodiment, the LED light source has a plurality of reflector elements which are arranged between the plurality of light emitting diodes and which are thermally conductively connected to the light emitting diodes. The reflector elements are in this respect located at the side remote from the installation section of the housing element, i.e. in the position of use of the lighting unit the reflector elements face downward. The reflector elements primarily serve as reflector elements to distribute the light output by the light emitting diodes in accordance with a desired radiation angle characteristic. In addition, the reflector elements provide an improved heat distribution and act as a further cooling device in that they take up a portion of the waste heat of the light emitting diodes and output it to the inner space of the housing.

The spacing between a cover device of the housing or of the already named cover device at the lower side, on the one hand, and said reflector elements, on the other hand, preferably amounts to at least 5 mm. Sufficient air circulation in the inner space of the housing is hereby ensured to distribute the waste heat taken up by the reflector elements. The LED light source is thus also cooled by air circulation (i.e. convectively) and not only be thermal conductivity at the rear side over the installation section of the housing element.

It is furthermore preferred if each of said reflector elements has a flank which is inclined with respect to a surface normal to the plane of the two-dimensional arrangement of the light emitting diodes and which is arranged in a straight line parallel to this arrangement plane in a longitudinal section. It has been found that a radiation angle characteristic particularly suitable for outdoor lighting units can hereby be realized, with the characteristic being settable by selection of the inclination angle.

The reflector elements can in particular be arranged in web-shape and have a substantially trapezoidal or triangular transverse section, with the aforesaid flanks also being able to be concavely curved in cross-section. The reflector elements hereby have a particularly simple structure to simultaneously satisfy a cooling function and to effect a desired radiation angle characteristic which is selected, for example, in dependence on the installation height of the outdoor lighting unit.

Said reflector elements are preferably formed separately from one another and also separately from said carrier device of the LED light source. A modular design with a settable radiation angle characteristic hereby also results with respect to the LED light source.

In accordance with a further embodiment, the outdoor lighting unit has at least one electronic or electrical component separate from the LED light source, for example a transformer and/or a control unit which is thermally conductively connected to an associated fastening section of the housing element. This connection can be realized, for example, via an areal contact or via fastening spigots (so-called domes). The heat generated by said component is hereby output along the housing element both to the installation section for the LED light source and to the cooling section. It can hereby be achieved that the heat generated by said component is utilized to bring the LED light source quickly to the desired operating temperature after its switching on, with an overheating being avoided in that the heat Oust like the waste heat of the LED light source) is ultimately also transferred to the cooling section of the housing element.

In accordance with an advantageous further development of this embodiment, said fastening section is arranged at the lower side of the housing element between the installation section (for the LED light source) on the one hand and the explained holding section (for the fastening of the lighting unit to a holding device) on the other hand so that the heat generated by the component is also effectively transferred to the associated holding device. In other words, said electronic or electrical component, which generates a particularly high thermal output, is arranged adjacent to the holding section of the housing element so that the waste heat can be effectively output to the associated holding device.

It is preferred if in the region of said fastening section (for the electrical or electronic component) the housing element is higher relative to the installation section for the LED light source and/or has a larger material thickness. A higher mechanical stability can hereby be achieved in the region of said fastening section, in particular if it is arranged between said installation section and the holding section of the housing element, and the higher material use can also result in a better thermal distribution.

The invention will be explained in the following only by way of example with reference to the drawings. The direction indications named in the following relate to the position of use of the explained outdoor lighting unit.

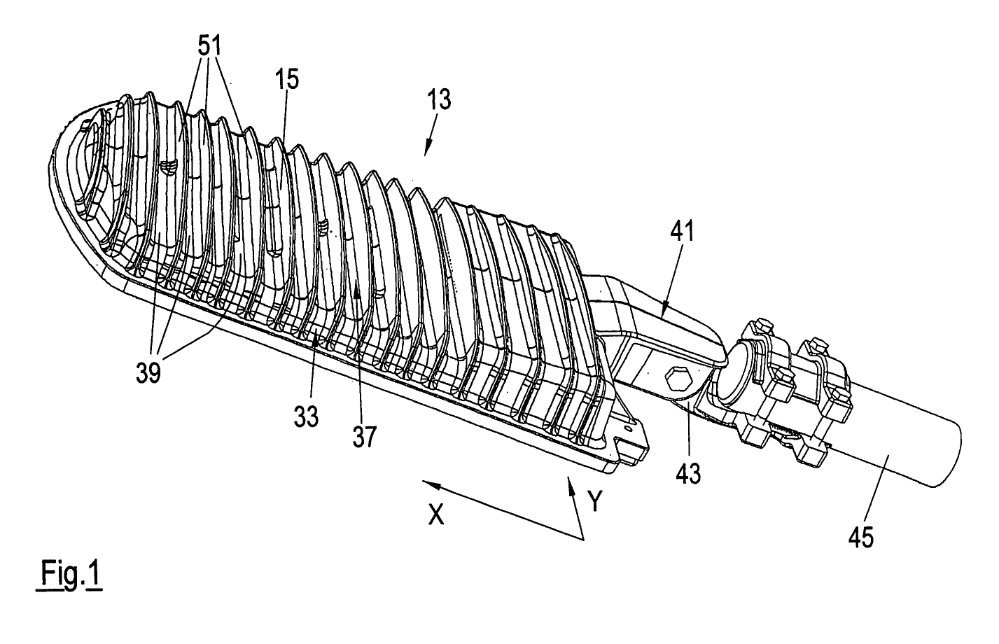

FIG. 1 shows an outdoor lighting unit in a perspective view obliquely from above;

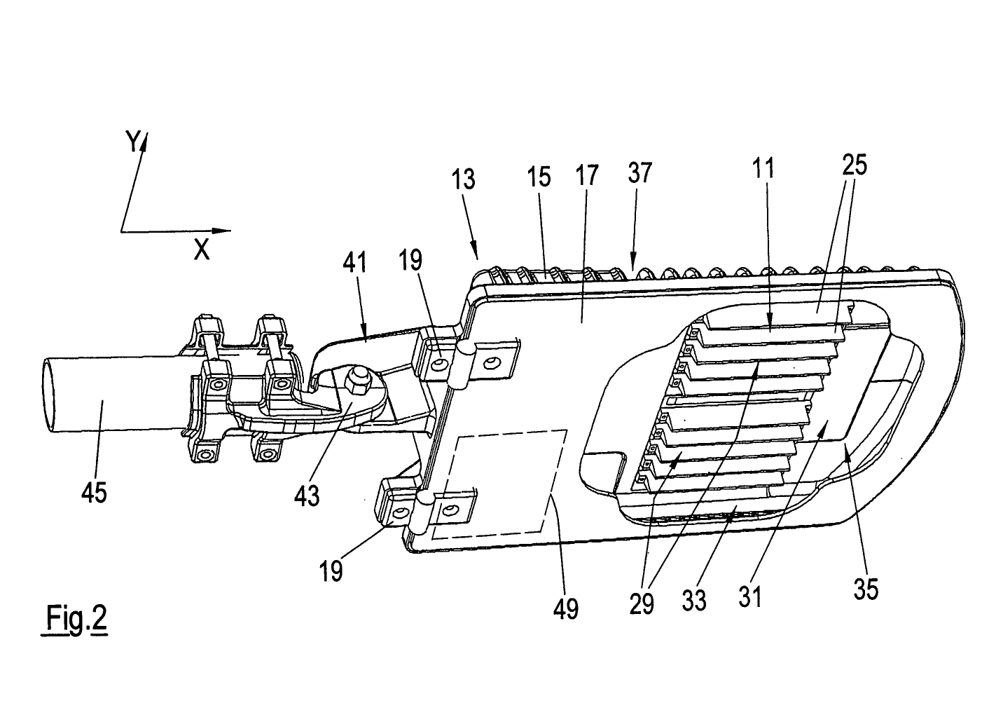

FIG. 2 shows the lighting unit in a perspective view obliquely from below (with two modules of the light source in a transverse arrangement);

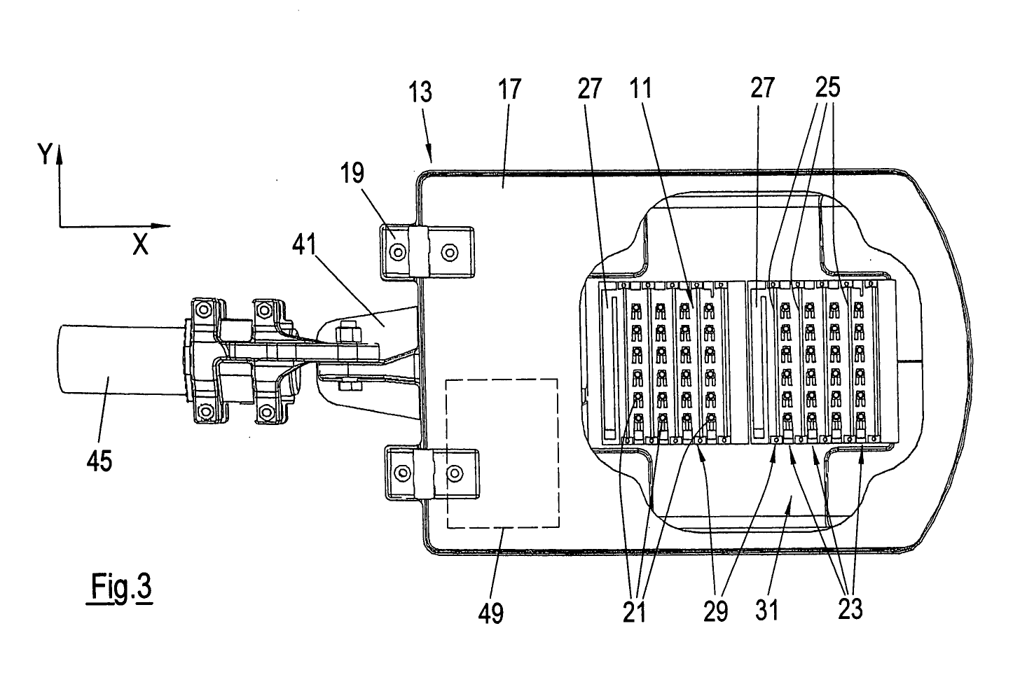

FIG. 3 shows a lower view of the lighting unit (with two modules of the light source in a lengthways arrangement);

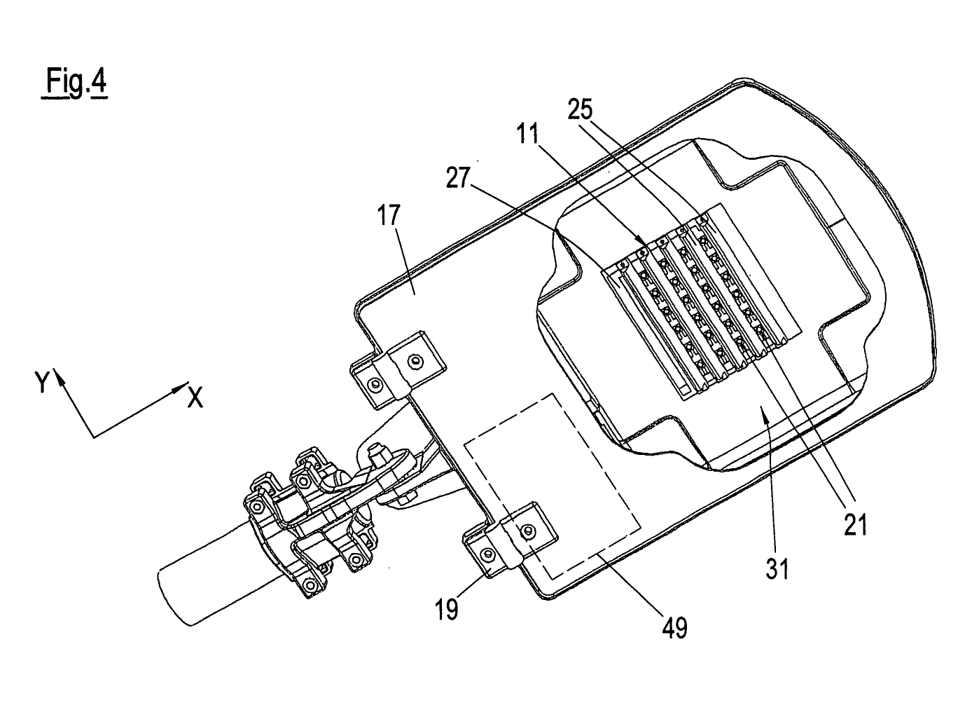

FIG. 4 shows the lighting unit in a perspective view from below (with a single module of the light source).;

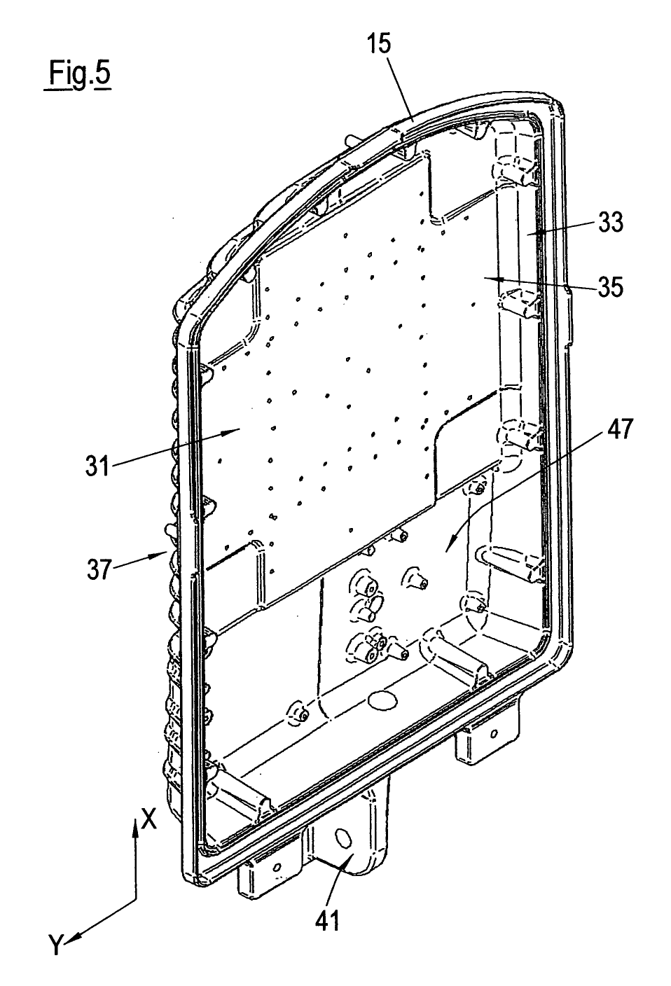

FIG. 5 shows a perspective view of the lower side of the housing element of the lighting unit in accordance with FIGS. 1 to 4;

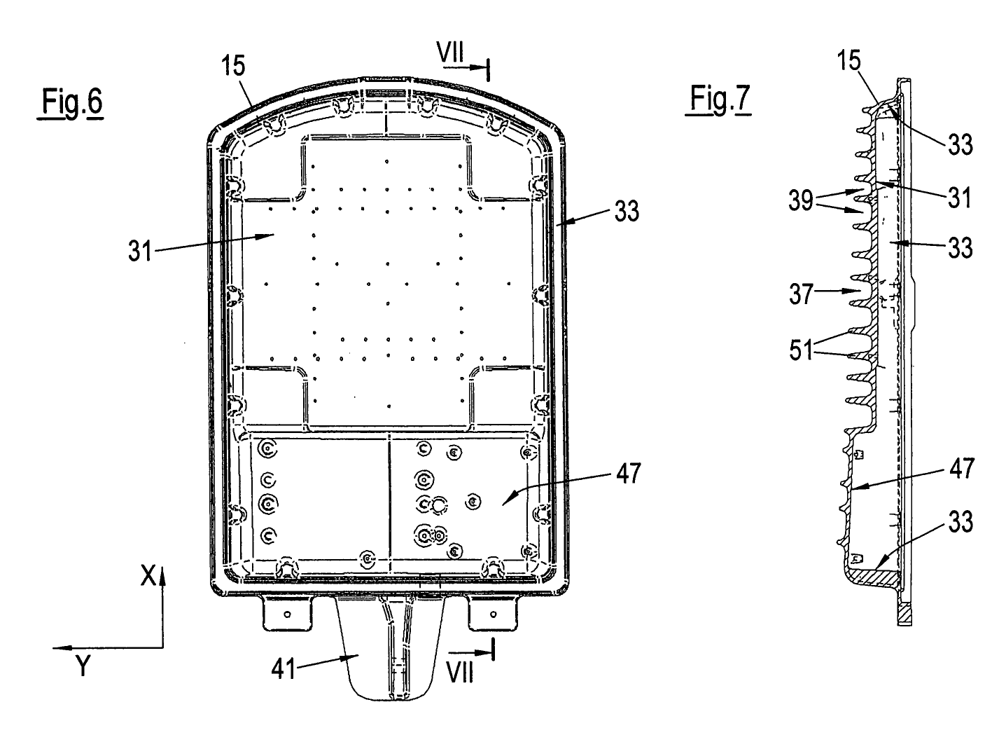

FIG. 6 shows a lower view of the housing element

FIG. 7 shows a cross-sectional view along the plane VII-VII of FIG. 6;

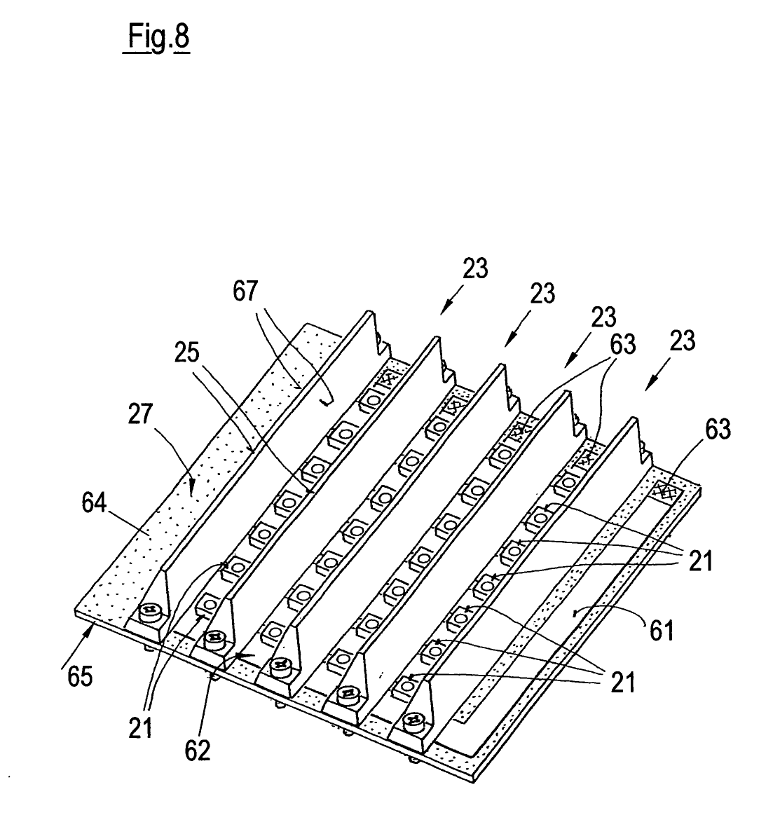

FIG. 8 shows a perspective view of a module of the light source of the lighting unit of FIGS. 1 to 4.

The outdoor lighting unit (in the following: lighting unit) shown in FIGS. 1 to 4 serves for the lighting of streets, sidewalks, outdoor industrial installations and the like. The lighting unit has an LED light source 11 and a housing 13. The housing 13 includes a single one-part housing element 15 which is made solid, i.e. substantially without hollow spaces (apart from openings for a mechanical or electric connection). The housing element 15 is formed as a casting made from an aluminum alloy resistant to sea water and thus resistant to weather without any additional surface treatment at the upper side, for example from AlMg4.5Mn. The housing 13 furthermore includes a cover device 17 in the form of a plate which is pivotably connected to the housing element 15 by means of two hinges 19 and which is made transparent in the region of the LED light source 11. The cover device 17 is fixable by means of fixing devices, not designated in any more detail, in the position shown closed in FIGS. 2 to 4.

The LED light source 11 has a plurality of light emitting diodes 21 in a two-dimensional arrangement, namely in an arrangement of a plurality of rows 23. The LED light source 11 furthermore includes a plurality of web-shaped reflector elements 25, with each reflector element 25 being arranged between two rows 23 of light emitting diodes 21 or adjacent to an outermost row 23 of light emitting diodes 21 (cf. in particular FIG. 3). The light emitting diodes 21 are electrically conductively and thermally conductively fastened to a planar carrier device 27. The reflector elements 25 are also thermally conductively fastened to the carrier device 27. The LED light source 11 can include a plurality of modules 29, with each module 29 having its own carrier device 27 with light emitting diodes 21 and reflector elements 25 arranged thereon. Two such modules 29 are shown in FIGS. 2 and 3. A single module 29 is shown in FIG. 4.

The housing element 15 includes a plurality of sections which are made integrally at the housing element 15 and which satisfy different functions. A planar, substantially “+” shaped installation section 31 is provided at the lower side of the housing element 15, and the rear side of the carrier device 27 of the LED light source 11 is fastened (for example, screwed, riveted or adhesively bonded) thereto areally and in a thermally conductive connection. The housing element 15 furthermore includes a peripheral wall section 33 at the lower side which projects downwardly from the plane of extent of said installation section 31, i.e. the wall section 33 protrudes downwardly with respect to the plane of the installation section 31. The wall section 31 hereby surrounds an installation volume 35 of the housing element 15 in which the LED light source 11 including the reflector elements 25 is arranged.

The housing element 15 additionally includes at the upper side an exposed cooling section 37 which is convexly curved (for example with respect to the plane of extent of the installation section 31) and has a plurality of cooling passages 39 which extend along the convex curvature. The housing element 15 furthermore has a holding section 41 which cooperates with a joint element 43 of an associated holding device 45 (e.g. mast) so that the lighting unit can be fastened to the holding device 45 in a self-supporting manner. Starting from the holding section 41, the housing element 15 extends along a lengthways direction X. Said cooling passages 39 extend substantially perpendicular to this lengthways direction X, i.e. along a transverse direction Y.

The housing element 15 furthermore has a fastening section 17 (cf. FIGS. 5 and 6) at the lower side. An electrical component 49 (e.g. a power pack) is fastened thereto in a thermally conductive manner (cf. FIGS. 2 to 4).

A particular advantage of the outdoor lighting unit shown comprises the one-part solid formation of the housing element 15 with the sections 31, 33, 37, 41 and 47. The total and single housing element 15 with an optimized thermal transition can namely hereby serve as a heat sink for the LED light source 11. Since the cover device 17 contacts the lower side of the peripheral wall section 33 and is thus thermally conductively connected to the wall section 33, the cover device 17 can serve as an additional heat sink for the waste heat of the LED light source 11. Heat can also be output to the associated holding device 45 via the holding section 41.

Due to the downwardly projecting peripheral wall section 33, the housing element 15 furthermore has a bell shape, with the LED light source 11 being provided in an elevated arrangement with respect to the lower side of the wall section 33 so that the LED light source 11 is particularly effectively protected against environmental influences. The plate-shaped cover crevice 17 contacting the lower side of the peripheral wall section 33 provides effective protection for the inner space of the housing element 15 against environmental influences with a simple structure.

Advantageous details of the lighting unit shown will be explained in the following.

Not only an increase in the surface is achieved by the formation of the cooling passages 39 at the convexly curved cooling section 37, but the heating of the environmental air at the upper side of the housing element 15 rather effects a rising of the heated air, with cooler air being able to flow on constantly along the cooling passages 39 also extending in the vertical direction. Substantially the total surface of the cooling section 37 at the upper side is hereby utilized for an effective thermal transfer to the environmental air. It is important in this respect that the width of the cooling passages 39 (with respect to half of its depth) is at least 2.5 times as large as the width of ribs 51 (with respect to half the height of the ribs) which are formed at the cooling section 37 between the cooling passages 39.

The formation of cooling passages 39 with such width relationships is also of particular advantage with respect to the stability toward wind loads which engage along the lengthways sides of the housing 13. An only small air resistance is namely produced along the transverse direction Y (despite the lengthways shape of the housing 13) by the wide cooling passages 39.

The wide cooling passages 39 furthermore contribute to the fact that precipitation can flow off effectively from the upper side of the housing 13 while forming a self-cleaning effect.

As regards the cooling of the LED light source 11, it is also of special advantage that the reflector elements 25 are thermally conductively connected to the light emitting diodes 21 (directly or via the carrier device 27). The reflector elements 25 thus serve as an additional cooling device.

It is also of advantage in this connection that the inner space of the housing 13 has a large clearance. In other words, a sufficient spacing between the light emitting diodes 21 or the reflector elements 25, on the one hand, and the upper side of the cover device 17, on the other hand, is provided to allow the formation of air circulation in the inner space of the housing 13. For example, the spacing between the lower side (i.e. the tip) of the reflector elements 25 and of the cover device 17 can amount to at least 5 mm. An effective air overflow of the light emitting diodes 21 is hereby made possible for the purpose of convective cooling.

Due to the arrangement of the fastening section 47 between the assembly section 31 for the LED light source 11, on the one hand, and the holding section 41, on the other hand, the waste heat generated by the electrical component 49 can be used so that the LED light source 11 fast reaches its predefined thermal operating point after its switching on.

There is a particular advantage with respect to the cooperation of the modules 29 of the LED light source 11 with the associated installation section 31 of the housing element 15. The substantially square modules 29 namely have an anisotropic radiation angle characteristic due to the web-shaped reflector element 25, i.e. much more light is radiated along a first direction than along a second direction perpendicular hereto. The modules 29 can, on the one hand, be fastened in different angular positions to the installation section 31 (i.e. the reflector elements 25 extend parallel or perpendicular to the lengthways direction X). On the other hand, selectively a single module 29 or a plurality of modules 29 in a lengthways arrangement or in a transverse arrangement can be fastened at the “+” shaped installation section 31 (i.e. next to one another along the lengthways direction X or next to one another along the transverse direction Y). By varying these parameters (angular position, direction of arrangement), the radiation angle characteristic of the lighting unit can thus be adapted in a simple manner to different applications or customer wishes while maintaining the same base structure and while using the same components.

Finally, the exact design of an LED light source 11 will be explained in more detail with reference to FIG. 8. FIG. 8 shows that the light emitting diodes 21 are fastened (for example soldered on, bonded or conductively adhered) to the carrier device 27 in accordance with a two-dimensional pattern. The light emitting diodes 21 are in this respect arranged in a plurality of rows 23, with a respective web-shaped reflector element 25 being fastened (e.g. screwed) between two adjacent rows 23 at the carrier device 27. Each reflector element 25 thus acts as a reflector for a plurality of light emitting diodes 21. The light emitting diodes 21 typically transmit visible light at a nominal radiation angle of approximately 120° with a substantially white emission spectrum. They are light emitting diodes 21 with high brightness to be able to illuminate large areas.

The carrier device 27 is a circuit board or another type of carrier plate having a plurality of metallic conductor tracks 61 and a plurality of connector surfaces (i.e. solder surfaces) 63. The carrier device 27 is made areally thermally conductive to distribute the heat generated by the light emitting diodes 21 areally along the carrier device 27 and to transfer it areally from the carrier device 27 to the installation section 31 of the housing element 15 (FIGS. 1 to 7). For this purpose, the conductor tracks 61 form, together with the connector surfaces 63, a regionally interrupted thermally conductive layer 62 at the front side of the carrier device 27. Additional thermally conductive layers (in particular full-area, i.e. uninterrupted, thermally conductive layers) can also be provided within the carrier device 27. The metallic conductor tracks 61 are for the larger part covered by a thin insulation layer 64 at the front side. The insulation layer 64 effects an electric insulation and simultaneously allows an effective thermal coupling of the reflector elements 25 via said thermally conductive layer 62 (i.e. via the conductor tracks 61) with the rear side of the light emitting diodes 21 so that the reflector elements 25 serve as a cooling device for the light emitting diodes 21. For this purpose, the light emitting diodes are partly seated on the conductor tracks 61 and the reflector elements 25 overlap (via said insulations layer 64) with lateral regions of the conductor paths 61. At the rear side, the carrier device 27 of the LED light source 11 has an electric insulating layer 65 to effect a reliable electric insulation from the installation section 31 of the housing element 15.

The reflector elements 25 have a trapezoidal cross-section, with the reflector elements 25 converging as the distance from the carrier device 27 increases, i.e. along a surface normal of the carrier device 27. Each reflector element 25 has a respective flank 67 along its two lengthways sides which forms the actual reflector surface. These flanks 67 are inclined by a predefined angle of inclination with respect to the surface normal of the carrier device 27. It can be seen from FIG. 8 that the flanks 67 are made in a straight line in a lengthways section parallel to the plane of extent of the carrier device 27.

Since the reflector elements 25 are formed separately from the carrier device 27, the LED light source 11 has a modular structure. It is hereby possible selectively to configure a respective LED light source 11 with one of a plurality of different sets of reflector elements 25 which in particular differ with respect to said angle of inclination of the flanks 67. An adaptation of the outdoor lighting unit to different applications or customer wishes can hereby additionally take place.

It is also of special advantage in this respect that no further optical elements are absolutely necessary due to the use of the web-shaped reflector elements 25. The LED light source 11 can in particular be formed without separate lenses. A simple transparent cover (cover device 17) is sufficient as protection against contamination.

### REFERENCE NUMERAL LIST

11 LED light source
13 housing
15 housing element
17 cover device
19 hinge
21 light emitting diode
23 row
25 reflector element
27 carrier device
29 module
31 assembly section
33 wall section
35 installation volume
37 cooling section
39 cooling passage
41 holding section
43 joint element
45 holding device
47 fastening section
49 electrical component
51 rib
61 conductor track
62 thermally conductive layer
63 connector surface
64 insulating layer
65 insulating layer
67 flank
X lengthways direction
Y transverse direction

1. An outdoor lighting unit for lighting streets, sidewalks, outdoor industrial installations and the like, having an LED light source (11) which includes a plurality of light emitting diodes (21) in a two-dimensional arrangement and having a housing (13), wherein the housing has a single-part solid housing element (15) which has at least one planar installation section (31) at its lower side, with a rear side of the LED light source (11) being arranged areally and in a thermally conductive connection at said installation section, wherein the housing element furthermore has a peripheral wall section (33) at the lower side which projects downward from the plane of the installation section (31), wherein the housing element furthermore has an exposed cooling section (37) at an upper side which is convexly curved and has a plurality of cooling passages (39) which extend along the convex curvature, and wherein the housing element has a holding section (41) by means of which the lighting unit is fastenable in a self-supporting manner to a holding device (45).

2. A lighting unit in accordance with claim 1, wherein the housing element (15) extends, starting from the holding section (41), along a lengthways direction (X), wherein the cooling passages (33) extend substantially perpendicular to the lengthways direction.

3. A lighting unit in accordance with claim 1,
wherein the housing element (15) is a casting.

4. A lighting unit in accordance with claim 1,
wherein the housing element (15) is produced from an aluminum alloy resistant to sea water and without surface treatment at the cooling section (37).

5. A lighting unit in accordance with claim 1,
wherein the cooling passages (39) have a width at half their depth which is at least 2.5 times as large as the width of ribs (51) which are formed at the cooling section (37) between the cooling passages.

6. A lighting unit in accordance with claim 1,
wherein the cooling passages (39) have a width of at least 10 mm at half their depth.

7. A lighting unit in accordance with claim 6,
wherein the cooling passages (39) have a depth of at least 15 mm.

8. A lighting unit in accordance with claim 7,
wherein the base of the cooling passages (39) is curved concavely in cross-section.

9. A lighting unit in accordance with claim 1,
wherein the housing (13) furthermore has a cover device (17) which is fastenable to the lower side of the wall section (33) of the housing element (15) and which is transparent at least in the region of the LED light source (11).

10. A lighting unit in accordance with claim 9,
wherein the cover device (17) is thermally conductively connected to the peripheral wall section (33) of the housing element (15) so that the cover device also forms a heat sink for the waste heat of the LED light source (11).

11. A lighting unit in accordance with claim 9,
wherein the spacing between the light emitting diodes (21) of the LED light source (11) and of the cover device (17) amounts to at least 10 mm so that air circulation can form within the housing (13) for the purpose of a convective cooling of the LED light source (11).

12. A lighting unit in accordance with claim 9,
wherein the cover device (17) is pivotably connected to the housing element (15).

13. A lighting unit in accordance with claim 1,
wherein the LED light source (11) has an electric insulation layer at the rear side.

14. A lighting unit in accordance with claim 1,
wherein the LED light source (11) is screwed, riveted or adhesively bonded to the installation section (31) of the housing element (15).

15. A lighting unit in accordance with claim 1,
wherein the housing element (15) has at least two installation sections (31) for a respective module (29) of the LED light source (11), with the installation sections (31) extending along different planes or being arranged mutually inclined.

16. A lighting unit in accordance with claim 1,
wherein the LED light source (11) selectively has one or more modules (29) which have an anisotropic radiation angle characteristic, wherein the installation section (31) of the housing element (15) is formed to selectively receive a single module, or a plurality of modules in a lengthways arrangement, or a plurality of modules in a transverse arrangement, so that the lighting unit can be adapted to different applications by variable configuration of the installation section (31).

17. A lighting unit in accordance with claim 16,
wherein the modules (29) of the LED light source (11) have a substantially square outline.

18. A lighting unit in accordance with claim 16,
wherein the respective module (29) is selectively fastenable in a lengthways orientation or in a transverse orientation to the installation section (31) of the housing element (15).

19. A lighting unit in accordance with claim 1,
wherein the installation section (31) of the housing element (15) has a “+” shape.

20. A lighting unit in accordance with claim 1,
wherein the surface of the installation section (31) of the housing element (15) has a smaller roughness than the surface of the cooling section (37).

21. A lighting unit in accordance with claim 1,
wherein the LED light source (11) has a carrier device (27) to which the light emitting diodes (21) are electrically conductively and thermally conductively connected, with a rear side of the carrier device being arranged areally and in a thermally conductive connection to the installation section (31) of the housing element (15).

22. A lighting unit in accordance with claim 21,
wherein the carrier device (27) is made areally thermally conductive to distribute the heat generated by the light emitting diodes (21) areally along the carrier device and to transfer it areally from the carrier device to the installation section (37) of the housing element (25).

23. A lighting unit in accordance with claim 1,
wherein the wall section (33) of the housing element (15) surrounds an installation volume (35) in which the LED light source (11) together with a reflector device is arranged.

24. A lighting unit in accordance with claim 1,
wherein the LED light source (11) has a plurality of reflector elements (25) which are arranged between the light emitting diodes (21) and are thermally conductively connected to the light emitting diodes so that the reflector elements act as an additional cooling device.

25. A lighting unit in accordance with claim 24,
wherein the housing (13) furthermore has a cover device (17) which is fastenable to the lower side of the wall section (33) of the housing element (15) and which is transparent at least in the region of the LED light source (11), wherein the spacing between a or the cover device (17) of the housing (15) and the reflector elements (25) amounts to at least 5 mm so that air circulation can form within the housing (13) for the purpose of a convective cooling of the LED light source (11).

26. A lighting unit in accordance with claim 24,
wherein each reflector element (25) has at least one flank (67) which is inclined to the arrangement plane of the light emitting diodes (21) with respect to a surface normal and which is formed in a straight line parallel to the arrangement plane of the light emitting diodes in a longitudinal section.

27. A lighting unit in accordance with claim 24,
wherein the reflector elements (15) are web-shaped and have a trapezoidal or triangular cross-section.

28. A lighting unit in accordance with claim 24,
wherein each reflector element (25) is arranged adjacent to a row (23) of light emitting diodes (21) or between two rows of light emitting diodes.

29. A lighting unit in accordance with claim 24,
wherein the reflector elements (26) are formed separately from one another.

30. A lighting unit in accordance with claim 24,
wherein the LED light source (11) has a carrier device (27) having a thermally conductive layer (62), wherein the light emitting diodes (21) are thermally conductively connected to the thermally conductive layer (62), and wherein the reflector elements (25) are also thermally conductively connected to the thermally conductive layer (62).

31. A lighting unit in accordance with claim 1,
wherein the LED light source (11) is made without separate lenses.

32. A lighting unit in accordance with claim 1,
wherein the lighting unit has at least one electronic or electrical component (49) which is separate from the LED light source (11) and which is thermally conductively connected to a fastening section (47) of the housing element (15) so that the heat generated by the component is output both to the installation section (31) for the LED light source (11) and to the cooling section (37).

33. A lighting unit in accordance with claim 32,
wherein the fastening section (47) for the component (49) is arranged at the lower side of the housing element (15) between the installation section (31) for the LED light source (11) and the holding section (41) so that the heat generated by the component can also be effectively transferred to the holding device (45).

34. A lighting unit in accordance with claim 32,
wherein the housing element (15) is higher in the region of the fastening section (17) for the component (49) relative to the installation section (31) for the LED light source (11).

35. A lighting unit in accordance with claim 1,
wherein the LED light source (11) comprises at least two modules (29) which have an anisotropic radiation angle characteristic and which are selectively fastenable in a lengthways orientation or in a transverse orientation to the installation section (31) of the housing element (15), wherein the installation section (31) of the housing element (15) has a “+” shape and is adapted to selectively receive a single one of the modules (29), or a plurality of the modules (29) in a lengthways arrangement, or a plurality of the modules (29) in a transverse arrangement, so that the lighting unit can be adapted to different applications by variable placement of modules (29) to the installation section (31).

36. A lighting unit in accordance with claim 35,
wherein in each module (29) of the LED light source (11) the light emitting diodes (21) are arranged in a plurality of rows (23), wherein each module (29) of the LED light source (11) has a plurality of web-shaped reflector elements (25) which are arranged adjacent to a row (23) of light emitting diodes (21) or between two rows (23) of light emitting diodes (21), wherein each reflector element (25) has at least one flank (67) which is inclined with respect to the installation section (31) of the housing element (15).

37. A lighting unit in accordance with claim 1,
wherein the light emitting diodes (21) are arranged in a plurality of rows (23), wherein the LED light source (11) has a plurality of web-shaped reflector elements (25) which are arranged adjacent to a row (23) of light emitting diodes (21) or between two rows (23) of light emitting diodes (21), the reflector elements (25) being thermally conductively connected to the light emitting diodes so that the reflector elements act as an additional cooling device, wherein the LED light source (11) comprises a carrier device (27) having a thermally conductive layer (62), wherein the light emitting diodes (21) are thermally conductively connected to the thermally conductive layer (62), and wherein the reflector elements (25) are also thermally conductively connected to the thermally conductive layer (62).

38. A lighting unit in accordance with claim 37,
wherein a rear side of the carrier device (27) is arranged areally and in a thermally conductive connection to the installation section (31) of the housing element (15) such that the carrier device (27) transfers heat generated by the light emitting diodes (21) areally to the installation section (37) of the housing element (25).
